(19) United States
(12) Patent Application Publication
(10) Pub. No.: US 2017/0126542 A1
(43) Pub. Date: May 4, 2017

(54) ICN Based Distributed Resource Directory for IoT Resource Discovery and Routing

(71) Applicant: Futurewei Technologies, Inc., Plano, TX (US)

(72) Inventor: Lijun Dong, San Diego, CA (US)

(21) Appl. No.: 14/925,525

(22) Filed: Oct. 28, 2015

(51) Int. Cl. H04L 12/751; H04L 12/24; H04L 29/08

(52) U.S. Cl. CPC H04L 45/02; H04L 67/12; H04L 41/12

(57) ABSTRACT

A method implemented in a network element (NE) configured to operate in an information centric network (ICN), the method comprising receiving, from a client via a receiver, a Resource Directory (RD) lookup message directed to a distributed RD database and comprising a lookupType field and an attribute value pair; converting the RD lookup message into an RD Lookup Forward (RDLF) comprising an RDLF lookupType field set to the lookupType field of the RD lookup message, an RDLF Time-To-Live (TTL) set to a largest number of hops that can be traversed in the ICN, and an RDLF attribute value pair set to the attribute value pair of the RD lookup message; and determining a forwarding interface list based on matching, to the attribute value pair, a routing entry from a Routing Table corresponding to the attribute value pair, wherein the Routing Table comprises routing information through the ICN to content mapped to a plurality of attribute value pairs.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A Representational State Transfer (REST) architecture is an abstraction of architectural elements within a distributed hypermedia system. REST ignores the details of component implementation and protocol syntax in order to focus on the roles of components, the constraints upon their interaction with other components, and their interpretation of significant data elements. REST encompasses the fundamental constraints upon components, connectors, and data that define the basis of the Web architecture, and thus the essence of its behavior as a network-based application. Unlike a distributed object style, where all data is encapsulated within and hidden by the processing components, the nature and state of an architecture's data elements is a key aspect of REST.

### SUMMARY

In one embodiment, the disclosure includes a network element (NE) configured to operate in an information centric network (ICN), the NE comprising a receiver configured to receive, from an endpoint, an Internet of Things (IoT) resource registration comprising a Resource Directory (RD) entry comprising an attribute value pair; a memory comprising a local portion of a distributed RD database and a candidate-to-be-published list; a processor coupled to the receiver and the memory, wherein the processor is configured to insert the attribute and value pair in the candidate-to-be-published list; and store the RD entry in the local portion of the distributed RD database; and a transmitter coupled to the processor and configured to transmit an RD Entry Advertisement (RDEA) message comprising attribute value pairs copied from the candidate-to-be-published list to a plurality of neighboring NEs within the ICN for storage in a remote portion of the distributed RD database when a number of the attribute value pairs in the candidate-to-be-published list reaches a threshold.

In another embodiment, the disclosure includes a method implemented in an NE configured to operate in an ICN, the method comprising receiving, from a client via a receiver, a RD lookup message directed to a distributed RD database and comprising a lookupType field and an attribute value pair; converting the RD lookup message into an RD Lookup Forward (RDLF) comprising an RDLF lookupType field set to the lookupType field of the RD lookup message, an RDLF TTL set to a largest number of hops that can be traversed in the ICN, and an RDLF attribute value pair set to the attribute value pair of the RD lookup message; and determining a forwarding interface list based on matching, to the attribute value pair, a routing entry from a Routing Table corresponding to the attribute value pair, wherein the Routing Table comprises routing information through the ICN to content mapped to a plurality of attribute value pairs.

In yet another embodiment, the disclosure includes a method implemented in an NE configured to operate in an ICN, the method comprising receiving, via a receiver, an RDLF message comprising at least one attribute value pair; determining whether a matching RD entry is contained in a local RD database based on the at least one attribute value pair; retrieving a resource from an endpoint for the matching RD entry from a local portion of a distributed RD database; and sending, through a transmitter, the resource to a client that requested the resource.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an RD employed within a Constrained RESTful Environment (CoRE).

FIG. 2 is an ICN Based RD Network Architecture implementation of a CoRE that distributes an RD to various NEs within the ICN.

FIG. 3 is a schematic diagram of an embodiment of an NE within an ICN.

FIG. 4 is a schematic diagram of an embodiment of an architecture of a Router RD configured within an ICN Based RD Network Architecture.

FIG. 5 is a flowchart of an embodiment of a method employed by an NE configured within an ICN to store a new RD entry.

FIG. 6 is a flowchart of an embodiment of a method employed by an NE configured within an ICN to remove a new RD entry.

FIG. 7 is a flowchart of an embodiment of a method employed by an NE configured within an ICN to process an Routing Table Advertisement (RTA) message.

FIG. 8 is a flowchart of an embodiment of a method employed by an NE configured within an ICN to process an RDEA message.

FIG. 9 is a flowchart of an embodiment of a method employed by an NE configured within an ICN to process an Attribute-Value Advertisement Cancellation (AVAC) message.

FIG. 10 is a protocol diagram describing communication between a client, an NE configured within an ICN hosting an RD Parameter Registry, and another NE configured within the ICN hosting a Link Attribute Value Registry.

FIGS. 11A and 11B are a flowchart of an embodiment of a method employed by an NE configured within an ICN to process an RD lookup message.

FIG. 12 is a protocol diagram describing an embodiment of a message flow of resource lookup request from a client through an ICN.

FIG. 13 is a flowchart of an exemplary embodiment employed by an NE in an ICN to receive and process an RD lookup message comprising an attribute value pair received from a client when an IoT resource corresponding to the attribute value pair is not stored on the NE in a local portion of a distributed RD database or an endpoint serviced directly by the NE.

FIG. 14 is a flowchart of an exemplary embodiment employed by an NE in an ICN to receive and process an RD lookup message comprising an attribute value pair received from a client when an IoT resource corresponding to the attribute value pair is not stored on the NE in a local portion of a distributed RD database or an endpoint serviced directly by the NE.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Constrained CoREs employ a REST architecture for constrained nodes (e.g., 8-bit microcontrollers) and networks (e.g., Internet Protocol (IP) version 6 (IPv6) over Low-Power Wireless Personal Area Networks (6LoWPANs)). The discovery of resources hosted by a constrained server within a CoRE is one aspect in machine-to-machine/Internet of Things applications where there are no humans in the loop and static interfaces may result in fragility in the overall architecture. The constrained server provides Universal Resource Identifiers (URIs) or links for the resources as well as attributes associated with the resources. A CoRE may define a Resource Directory (RD) that provides a set of REST interfaces for Endpoints (EPs) to register and maintain sets of RD entries as well as to provide a mechanism for clients of the CoRE to lookup resources within the CoRE. In an embodiment, the RD is distributed. The interfaces allow a client to specify and assign attributes to a resource, such as endpoint name, domain, resource type, endpoint type, and link attribute parameters.

A CoRE may define a link format which describes the attributes about the resources hosted by endpoints (EPs) as well as possible further link relations and may be specified for use in CoRE Resource Discovery. The link format may provide a link description for an associated link. In an embodiment, the link format is carried as a payload and is assigned an Internet media type. In an embodiment, a well-known relative URI (e.g., “/.well-known/core”) is defined as a default entry point for requesting the list of links comprising resources hosted by a server and may be employed for CoRE Resource Discovery. Additionally, a collection of links may be carried as a resource within a CoRE.

An ICN is a type of network architecture that focuses on information delivery. ICN has emerged as a candidate for an architecture of the future Internet as well as Internet of Things (IoT). ICN integrates name-based routing and caching as part of the network infrastructure. ICNs integrate name based routing into the router (i.e., router can route request based on content name). Network Elements within an ICN, such as routers, can cache content as a part of the network infrastructure (e.g., embedded caching capacity). ICN's distributed and in-network routing characteristics make it a favorable architecture to implement de-centralized IoT resource registration and lookup interfaces in the ICN routers.

ICNs may also be known as content-aware, content-centric, or data specific networks. ICNs shift the IP communication model from a host-to-host model to an information-object-to-object model. The IP host-to-host model addresses and identifies data by storage location, for example, by host IP address, whereas the information-object-to-object model employs a non-location based addressing scheme that is content-based, even though the packet forwarding policies can make use of geographical routing schemes. The entities that are distributed or operated on in an ICN communication model are information objects. Some examples of information objects may include content, data streams, services, user entities, and/or devices. In an ICN, information objects are assigned entity-based names (e.g., application-based, host-based, device-based), which are used to address the information objects, decoupling the information objects from locations. Routing to and from the information objects are based on the assigned names. ICN provisions for in-network caching, where a wide variety of network devices or elements serve as temporary content servers.

A content allocation architecture in an ICN provides functions for content-based resource allocation. Within this type of architecture, scheduling policies may take advantage of these functions to achieve a significant gain over IP resource allocation procedures. In such a network, the data-forwarding capability (e.g., the data/forwarding plane) may be decoupled from the routing, resource, and other management functionality (e.g., the control plane). In various embodiments, NEs within the ICN may be configured to implement the forwarding/data plane functions, while the control plane functions may be provided by an NE configured as an ICN controller.

The ability of an ICN to efficiently forward packets (e.g., Interest, Data) is a concern in the design of an ICN architecture due to the impact on overall networking performance. In an ICN, forwarding decisions are made based on routing tables that are employed by the ICN controller to establish a Forwarding Information Base (FIB). Each NE configured to function within the forwarding plane employs an FIB, which establishes the forwarding strategy for any received requests (e.g., Interest packets). Because forwarding information is derived from the routing protocols implemented by the NE within the ICN, routing techniques are designed to maximize forwarding efficiency. Further, each NE configured to function within the forwarding plane employs a Pending Interest Table (PIT). Entries in the PIT correspond to Forwarded Interest packets received and then forwarded on an NE. NEs determined as the next hop along a return path of received Data packets are based on the corresponding PIT entries.

Disclosed herein is a distributed RD architecture based on ICN where RDs are deployed in a distributed manner in Gateways, Base Stations, and Routers within the ICN. In an embodiment, the distributed RDs are named Gateway RDs, Base Station RDs, and Router RDs respectively. The distributed Router RDs inherit and support the resource/group registration and lookup interface. In an embodiment, the Router RD architecture relates to RD entry caching and IoT resource discovery and routing. The Router RD architecture comprises RD Database, Routing Tables for IoT resources, an RD Entry In-Network Caching Component, an RD Entry Processing and Advertisement Component, a Routing Table Establishment and Advertisement Component, and an RD Lookup Processing and Forwarding Component. In various embodiments, the RD Database and Routing Tables are separate from the FIB and PIT and comprise different data sets. The RD Database stores all the RD entries on resources that are registered from the endpoints as well as the RD entries that are contained in the RD lookup response payload forwarded by the Router RD. The Routing Tables for IoT resources are based on the RD lookup interface where each Router RD may maintain resource type (rt) based routing table, entry type (et) based routing table, group (gp) based routing table, Interface (if) based routing table, etc. The RD Entry In-Network Caching Component allows the Router RD to cache the payload in RD lookup or retrieval response, which contains the RD entries sent from the replier. The RD Entry Processing and Advertisement Component provides a mechanism for the Router RD to advertise IoT resources to the adjacent routers by publishing the aggregated link attribute and value pairs. In an embodiment, a Router RD processes local and cached RD entries and aggregates them based on a set of parameters. The Routing Table Establishment and Advertisement Component defines a mechanism for the Router RD to build up local routing tables based on the remote routing tables and aggregated link attribute/value pairs advertised from remote routers as a Router RD periodically advertises its routing tables to the adjacent routers. RD Lookup Processing and Forwarding Component specifics that a lookup request is forwarded based on the routing tables that are specific to the parameters contained in the lookup request.

In an embodiment, a Resource Type attribute is an opaque string used to assign an application-specific semantic type to a resource within a CoRE. For example, a temperature resource could be an application-specific semantic type like “outdoor-temperature.” As another example, the temperature resource may be a URI referencing a specific concept in an ontology. Multiple Resource Types may be included as the value of this attribute.

In an embodiment, an Interface Description attribute is an opaque string used to provide a name or URI indicating a specific interface definition used to interact with a target resource. The Interface Description attribute may describe a generic REST interface to interact with a resource or a set of resources. In various embodiments, an Interface Description may be reused by different Resource Types. For example, the Resource Types “outdoor-temperature”, “dew-point”, and “relative-humidity” could each be accessible using a particular Interface Description.

In an embodiment, a maximum size estimate attribute provides an indication of a maximum size of a resource representation returned by performing a GET on an associated target URI. This attribute may not be included for small resources (e.g., resources that may be carried in a single Maximum Transmission Unit (MTU)), but may be included for larger resources (e.g., resources that cannot be carried in a single MTU).

In various embodiments, a link attribute value registry is employed within a CoRE. The link attribute value registry provides a vehicle to store CoRE parameters. In an embodiment, the link attribute value registry contains two sub-registries. One sub-registry provides a place to store values for Resource Type Link Target Attributes and the other sub-registry provides a place to store values for the Interface Descriptions. In one embodiment, a registration template for either sub-registry is: Attribute Value, Description, Reference, and optionally, Notes.

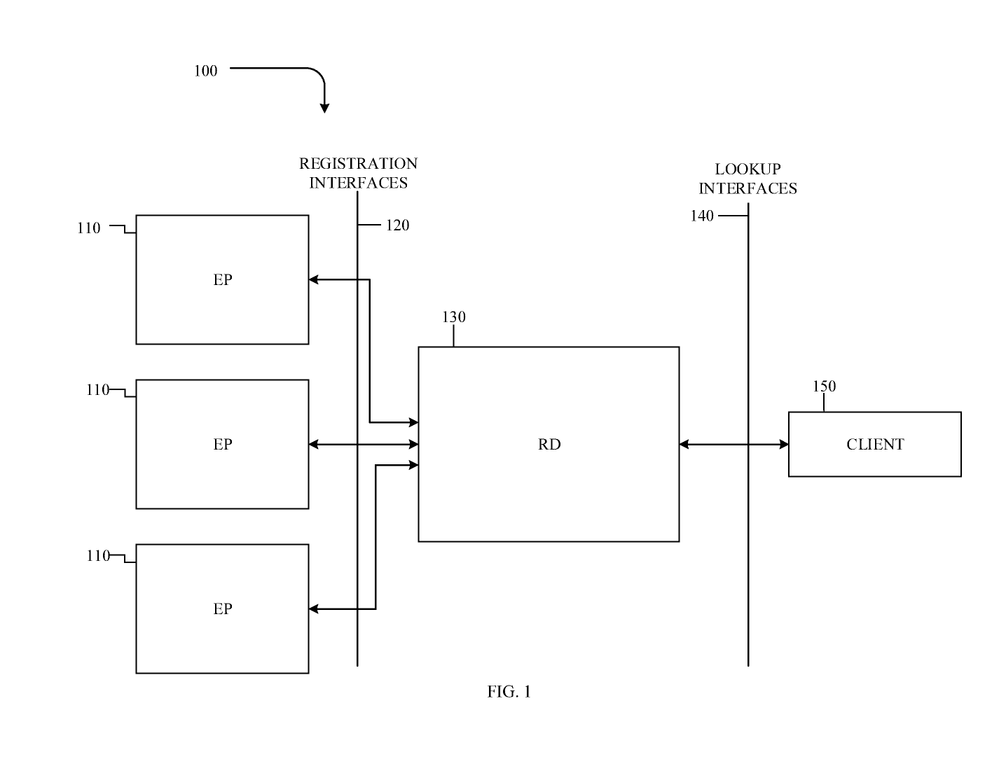

FIG. 1 is a schematic diagram 100 of an RD 130 employed within a CoRE. RD 130 may be employed as a repository for Links regarding resources that are hosted by endpoints 110. In various embodiments, an endpoint is a server associated with a scheme, IP address, and port (e.g., Context), thus a physical node may host one or more endpoints. RD 130 may implement a set of REST interfaces. In the disclosed embodiment, the REST interfaces include registration interfaces 120 and lookup interfaces for resources and groups of resources 140. Registration interfaces 120 provide a mechanism though which endpoints 110 may register and maintain sets of Web Links (e.g., resource directory entries). Lookup interfaces 140 provide a mechanism through which clients, such as client 150, may lookup resources or groups of resources from the RD or maintain groups. In various embodiments, a client may be an application or device employed to query the CoRE from resources.

In various embodiments, a resource registration request interface, such as registration interface 120, accepts, from an endpoint, a POST comprising a list of resources to be added to an RD, such as RD 130, in a message payload, in a CoRE Link Format, along with query string parameters indicating the name of the endpoint, the endpoint domain, and the lifetime of the registration. In an embodiment, parameters other than the endpoint name are optional. The RD may create a new resource or update an existing resource in the RD with the message payload. The RD may return a location of the RD to the endpoint. In various embodiments, the information contained in the RD regarding the resources contained on endpoints is active for the period indicated by the lifetime parameter.

In an embodiment, a registration request interface, such as registration interface 120, comprises a RD Function Set that specifies a path of the RD Function Set, as obtained from discovery, an Endpoint name that specifies an identifier that may be unique within a domain, a domain that specifies the domain to which the corresponding endpoint belongs, an Endpoint Type that specifies a semantic type of the endpoint, a Lifetime that specifies a lifetime of the registration in seconds (if no value is included for the lifetime variable a default value is used), and a Context that specifies a scheme, address, and port at which the server is available (if no value for the context is included the scheme of the protocol, source IP address, and source port of the register request are employed by default). In various embodiments, a group registration request interface, such as registration interface 120, accepts, from an endpoint, a POST comprising a list of groups to be added to or removed from the RD. Unlike an endpoint entry, however, a group entry comprises of a list of endpoints and does not have a lifetime. A group may have an associated multicast address to make use of multicast requests with a Constrained Application Protocol (CoAP). In various embodiments, an RD lookup interface, such as lookup interface 140, is employed for discovering resources or groups of resources registered with an RD. The RD lookup function set allows lookups for domains, groups, endpoints, and resources using attributes defined in the RD Function Set and for use with the CoRE Link Format.

An RD, such as RD 130 may employ a RD Parameter Registry. In various embodiments, the RD Parameter Registry is a sub-registry for registration and lookup parameters. Each entry in the RD Parameter Registry may include the human readable name of the parameter, the query parameter, and validity requirements if any and a description.

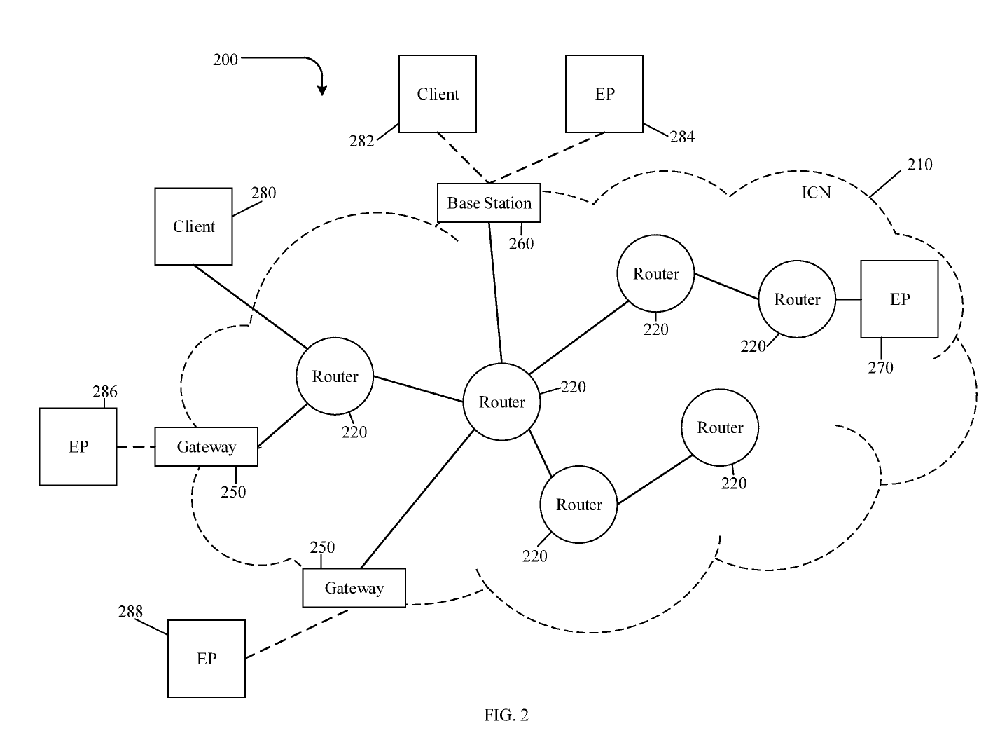

FIG. 2 is ICN Based RD Network Architecture 200 implementation of a CoRE that distributes an RD, such as RD 130, to various NEs within the ICN. The ICN 210 comprises NEs such as Routers 220, Gateways 250, and Base Stations 260 employed to regulate network traffic. In various embodiments, Gateways 250 regulate traffic between the ICN 210 and other dissimilar networks. In various embodiments, routers 220 regulate traffic within the ICN 210 and between other similar networks to the ICN. In various embodiments, gateways 250 are transceivers acting as a router for computers in the ICN and base stations 260 are transceivers acting as a router for user equipment in the ICN. Within the ICN Based RD Network Architecture 200 the RD is deployed in a distributed way to the Routers 220, Gateways 250, and Base Stations 260 that comprise the ICN 210. In various embodiments, the Routers 220, Gateways 250, and Base Stations 260 that contain the distributed RD are named Router RD, Gateway RD, and Base Station RD, respectively. Clients 280 and 282 may be substantially similar to client 150 and connect to the ICN 210 through Router 220 and Base Station 260, respectively.

In various embodiments, Router RDs, Gateway RDs, and Base Station RDs provide various interfaces, such as registration interfaces 120 and/or lookup interfaces 140 for resources and groups of resources. These provided interfaces may include a resource registration request interface, a group registration request interface, and an RD lookup interface. In some embodiments, the Router RDs, the Gateway RDs, and the Base Station RDs may host the RD information for the various attached endpoints. In various embodiments, a host RD is the RD where an endpoint registers resources and sends resource lookup requests.

In various embodiments, IoT resources are physical objects or “things” embedded with electronics, software, sensors, and network connectivity, which enables these objects to collect and exchange data. In various embodiments, an IoT resource(s) may be registered to a Router RD in the ICN Based RD Network Architecture 200 by an endpoint, such as, EPs 270, 284, 286, and 288. After the Router 220 accepts the registration of the resource, the IoT resource may be given a unique name. In an embodiment, the unique name serves as the URI for the assigned resource.

In various embodiments, a Router 220 may be configured as a Router RD, a Router, or a Legacy Router. When configured as a Router RD, Router 220 may provide a resource registration request interface, a group registration request interface, an RD lookup interface, and an RD parameter registry (detailed below). Additionally when configured as a Router RD, Router 220 may provide the in-network caching of RD discovery response (e.g., RD entries), and IoT resource discovery and routing functionalities. When configured as a Router, Router 220 may provide the in-network caching of RD discovery response (RD entries), provide IoT resource discovery, and opportunistically cache received RD entries but may not accept a resource registration and lookup directly from an endpoint. When configured as a legacy router, Router 220 could function as a named based ICN router or a legacy IP based router. In either case, Router 220 may not process requests through the various interfaces but may still forward unrecognized messages.

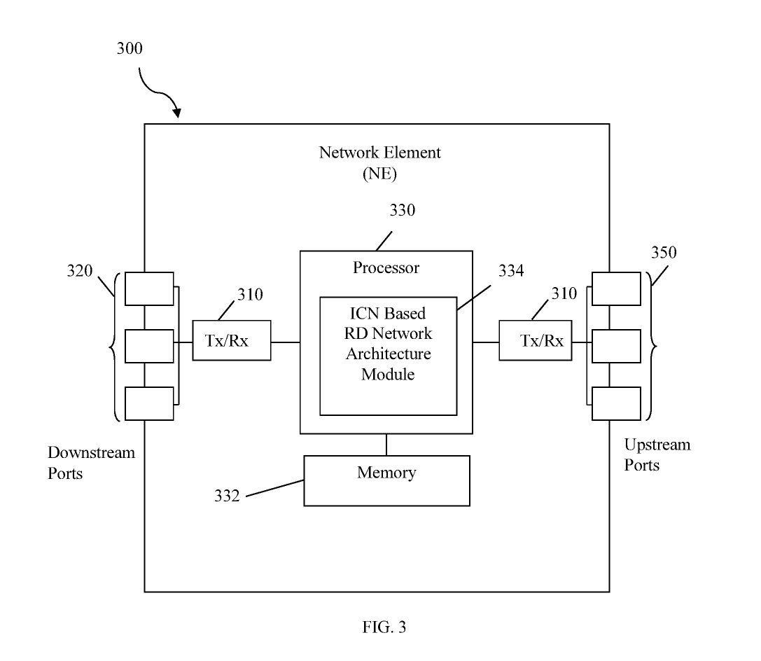

FIG. 3 is a schematic diagram of an embodiment of an NE 300, such as Router 220, Gateway 250, and/or Base Station 260, within an ICN, such as ICN 210. NE 300 may be implemented in a single node or the functionality of NE 300 may be implemented in a plurality of nodes. One skilled in the art will recognize that the term NE encompasses a broad range of devices of which NE 300 is merely an example. NE 300 is included for purposes of clarity of discussion, but is in no way meant to limit the application of the present disclosure to a particular NE embodiment or class of NE embodiments.

At least some of the features/methods described in the disclosure are implemented in a network apparatus or component such as an NE 300. For instance, the features/methods in the disclosure may be implemented using hardware, firmware, and/or software installed to run on hardware. The NE 300 is any device that transports packets through a network, e.g., a switch, router, bridge, server, a client, etc.

As shown in FIG. 3, the NE 300 may comprise transceivers (Tx/Rx) 310, which are transmitters, receivers, or combinations thereof. A Tx/Rx 310 is coupled to a plurality of downstream ports 320 (e.g., downstream interfaces) for transmitting and/or receiving packets from other nodes and a Tx/Rx 310 coupled to a plurality of upstream ports 350 (e.g., upstream interfaces) for transmitting and/or receiving packets from other nodes, respectively. A processor 330 is coupled to the Tx/Rxs 310 to process the packets and/or determine which nodes to send packets to. The processor 330 may comprise one or more multi-core processors and/or memory 332 devices, which function as data stores, buffers, Random Access Memory (RAM), Read Only Memory (ROM), etc. Processor 330 may be implemented as a general processor or may be part of one or more application specific integrated circuits (ASICs) and/or digital signal processors (DSPs). Processor 330 comprises an ICN Based RD Network Architecture Module 334, which implements at least some of the methods discussed herein such as methods 500. 600, 700, 800, 900, 1100, 1300, and 1400 described below. In an alternative embodiment, ICN Based RD Network Architecture Module 334 is implemented as instructions stored in memory 332, which are executed by processor 330, or implemented in part in the processor 330 and in part in the memory 332, for example a computer program product stored in a non-transitory memory that comprises instructions that are implemented by the processor 330. In another alternative embodiment, the ICN Based RD Network Architecture Module 334 is implemented on separate NEs. The downstream ports 320 and/or upstream ports 350 may contain electrical and/or optical transmitting and/or receiving components.

It is understood that by programming and/or loading executable instructions onto the NE 300, at least one of the processor 330, ICN Based RD Network Architecture Module 334, Tx/Rxs 310, memory 332, downstream ports 320, and/or upstream ports 350 are changed, transforming the NE 300 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design is developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

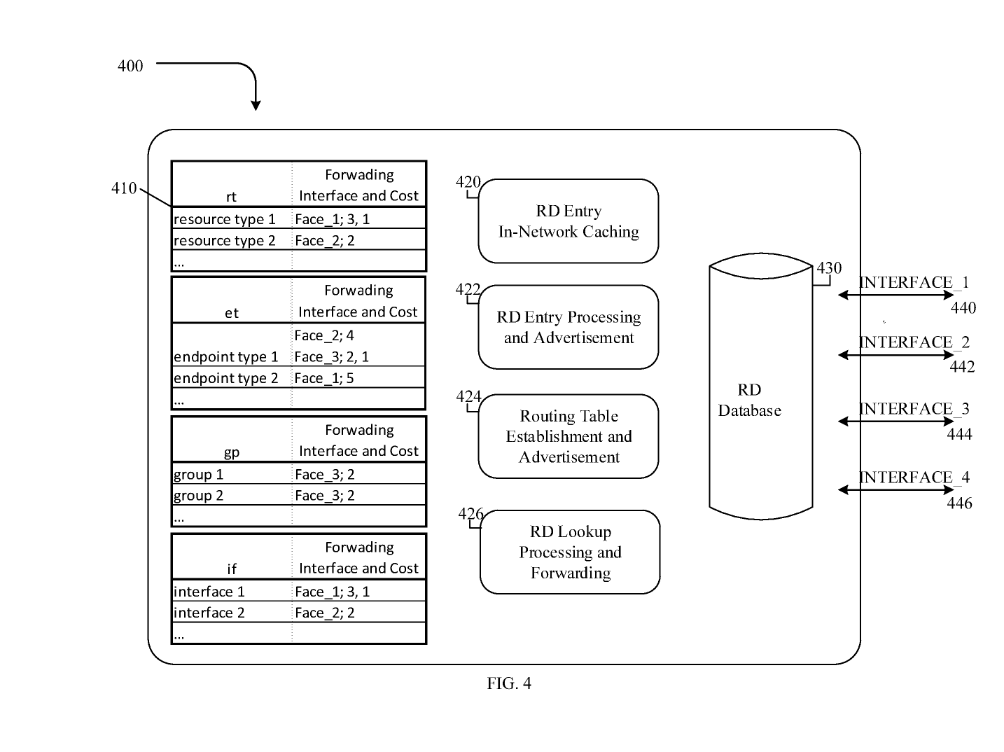

FIG. 4 is a schematic diagram of an embodiment of an architecture of a Router RD 400, such as Router 220, configured within an ICN Based RD Network Architecture, such ICN Based RD Network Architecture 200. The architecture comprises an RD database 430, routing tables for IoT resources 410, RD entry in-network caching component 420, RD entry processing and advertisement component 422, routing table establishment and advertisement component 424, RD lookup processing and forwarding component 426, and forwarding interfaces 440, 442, 444, and 446.

The RD Database 430 may store RD entries regarding resources that are registered from various endpoints as well as RD entries that are contained in the RD lookup response payload when forwarded by the Router RD. Routing Tables for IoT resources 410 are based on the RD lookup interface. An RD interface may allow a lookup of resources and groups based on parameters. In an embodiment, the parameters comprise entry point, domain, resource type, entry type, and resource link attribute parameters. For example, if ep is the name of an endpoint, which can be resolved by a domain name system (DNS) service, then d, the domain to which the endpoint is assigned, can also be resolved by the DNS service. Thus, each Router RD may maintain rt-based routing table, et-based routing table, gp-based routing table, and if-based routing table. In various embodiments, an rt-based routing table maintains possible resource types associated with IoT resources and the corresponding forwarding interfaces, an et-based routing table maintains possible endpoints and the corresponding forwarding interfaces, a gp-based routing table maintains possible groupings of endpoints and/or IoT resources and the corresponding forwarding interfaces, and an if-based routing table maintains possible interfaces and the corresponding forwarding interfaces.

In an embodiment, the RD entry in-network caching component 420 provides a mechanism by which the Router RD 400 may cache the payload in RD lookup or retrieval response. The lookup and retrieval responses each contain the RD entries sent from the replier. Therefore, each RD entry may be associated with ‘lt’ attribute (lifetime), which may be updated based on a difference between the time when the entry was cached and the time when it was created on the host RD.

In an embodiment, the RD entry processing and advertisement component 422 provides a mechanism by which the Router RD 400 processes local and cached RD entries and aggregates them based on associated parameters. The Router RD 400 may then advertise IoT resources to the adjacent routers by publishing the aggregated link attribute and value pairs.

In an embodiment, the routing table establishment and advertisement component 424 provides a mechanism by which the Router RD 400 periodically advertises its routing tables to the adjacent routers and provides a mechanism by which the Router RD 400 may build up routing tables based on the routing tables and aggregated link attribute/value pairs advertised from other routers with the ICN.

In an embodiment, RD lookup processing and forwarding component 426 provides a mechanism by which the Router RD may first check if there is RD entry stored/cached in the RD Database matching a requested RD entry. When a match is found, the router sends entry to the requester. Otherwise, the lookup request is forwarded based on the routing tables that are specific to the parameters contained in the lookup request. When the lookup request only contains one parameter, then the parameter specific routing table is used for the forwarding. When the lookup request contains multiple parameters that are connected by OR, then the interfaces in all corresponding routing tables are combined and used as the forwarding interface(s). When the lookup request contains multiple parameters that are connected by AND, then the joint set of the interfaces in all the corresponding routing tables are used as the forwarding interface(s).

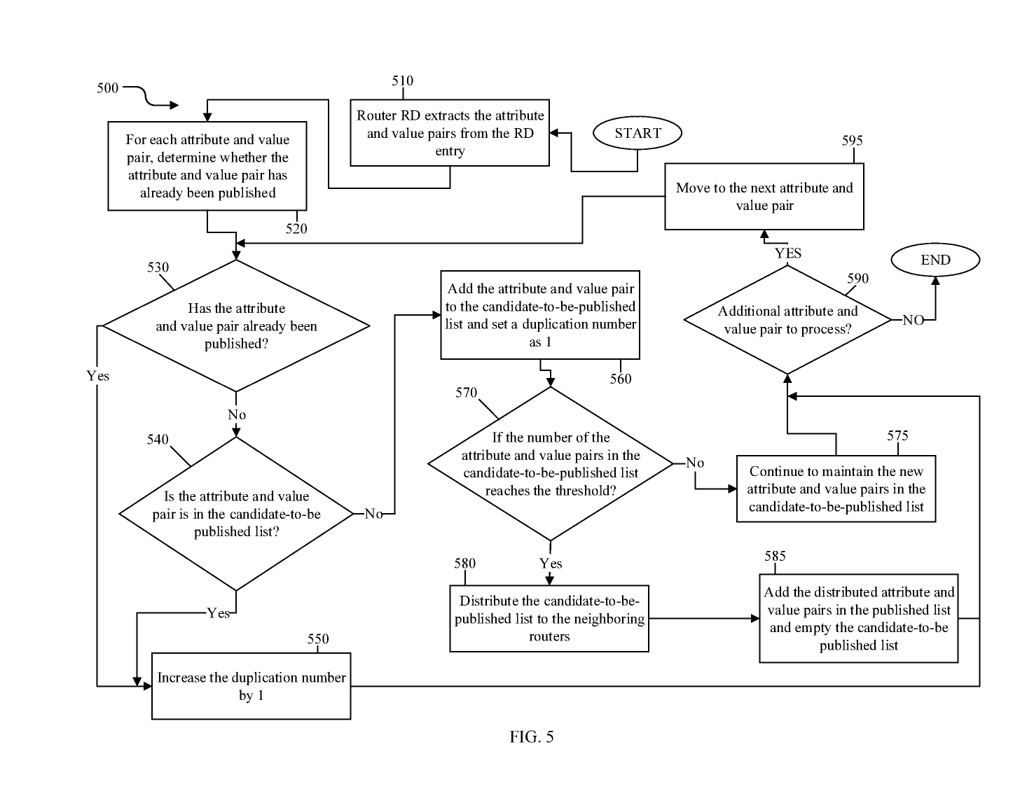

FIG. 5 is a flowchart of an embodiment of a method 500 employed by an NE, such as Router 220, NE 300, and/or Router RD 400, configured within an ICN, such as ICN 210, to store a new RD entry when the entry is received from, for example, an endpoint. Method 500 may be implemented when an NE in the ICN receives an IoT resource registration or caches an RD entry in the RD Database, such as RD Database 430. At step 510, the Router RD extracts attribute and value pairs from the RD entry. For example, three attribute and value pairs may be contained in a payload of the registration request and therefore processed by the Router RD upon receipt of the registration request. In one embodiment, only the attribute and value pairs that are specified in the RD lookup interface are processed. At step 520, for each attribute and value pair, the Router RD determines whether the attribute and value pair has already been published. At decision step 530, the Router RD proceeds to step 540 if the attribute and value pair has not been published. At decision step 530, the Router RD proceeds to step 550 if the attribute and value pair has been published. At decision step 540, the Router RD proceeds to step 550 if the attribute and value pair is in the candidate-to-be published list. At decision step 540, the Router RD proceeds to step 560 if the attribute and value pair is not in the candidate-to-be published list. At step 550, the Router RD increases the duplication number by one and proceeds to decision step 590. At step 560, the RD adds the attribute and value pair to the candidate-to-be-published list and sets a duplication number to one. At decision step 570, the Router RD proceeds to step 575 if a number of the attribute and value pairs in the candidate-to-be published list has not reached a threshold. At decision step 570, the Router RD proceeds to step 580 if a number of the attribute and value pairs in the candidate-to-be published list has reached a threshold. At step 575, the Router RD continues to maintain the new attribute and value pairs in the candidate-to-be-published list and proceeds to decision step 590. At step 580, the Router RD distributes the candidate-to-be-published list to neighboring routers via an RDEA message. At step 585, the Router RD adds the distributed attribute and value pairs to a published list and empties the candidate-to-be-published list and proceeds to decision step 590. At decision step 590, the Router RD proceeds to step 595 if there is an additional attribute and value pair to process. At decision step 590, the process ends if there is not an additional attribute and value pair to process. At step 595, the Router RD moves to the next attribute and value pair and proceeds to decision step 530.

In an embodiment, the RDEA message format comprises a Message Type attribute set to a value of RDEA, a Number of New Attribute-Value Pair attribute assigned to the number of attribute and value pairs contained within the message, and a number of New Attribute-Value Pair entries containing the attribute and value pairs being distributed within the RDEA message by the Router RD. The Number of New Attribute-Value Pairs field may indicate how many new attribute and value pairs are expected in the RDEA message.

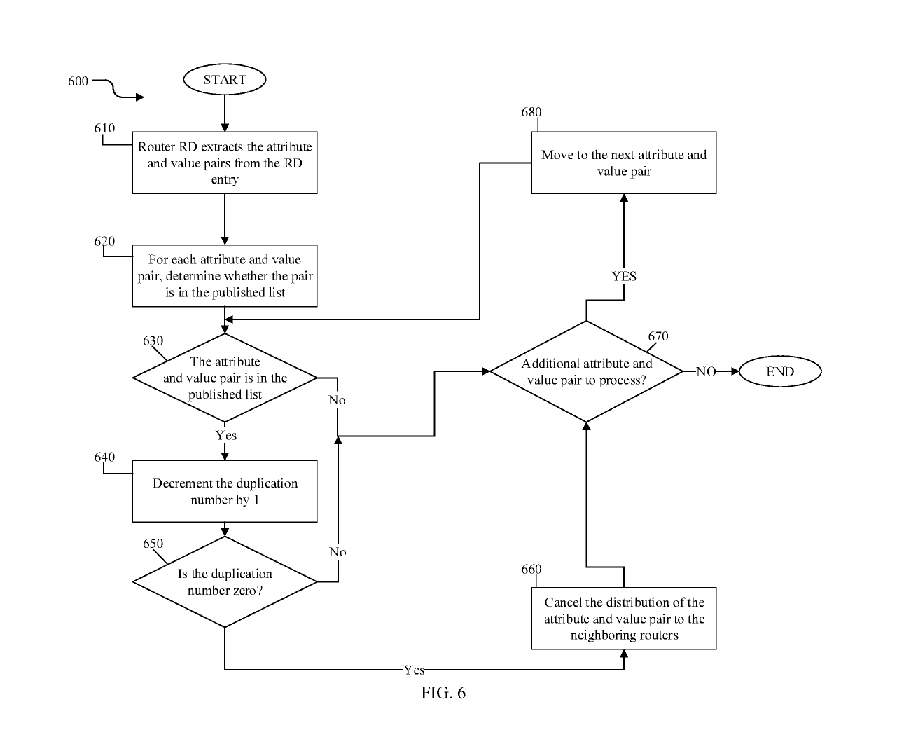

FIG. 6 is a flowchart of an embodiment of a method 600 employed by an NE, such as Router 220, NE 300, and/or Router RD 400, configured within an ICN, such as ICN 210, to remove a new RD entry when the Router RD receives a request to delete the entry or if the entry expires. At step 610, Router RD extracts the attribute and value pairs from the request to be deleted or expired entry. At step 620, for each attribute and value pair, the Router RD determines whether the attribute and value pair is in the published list. At decision step 630, the Router RD, proceeds to decision step 670 if the attribute and value pair is not in the published list. At decision step 630 the Router RD proceeds to step 640 if the attribute and value pair is in the published list. At step 640, the Router RD decrements the duplication number by one for the attribute and value pair. At decision step 650, the Router RD proceeds to step 660 if the duplication number for the attribute and value pair is zero. At decision step 650, the Router RD proceeds to step 660 if the duplication number for the attribute and value pair is zero. At step 660, the Router RD cancels the distribution of the attribute and value pair to the neighboring routers. In an embodiment at step 660, the Router RD sends an AVAC message to the neighboring routers. At decision step 670, the Router RD proceeds to step 680 if there is an additional attribute and value pair to process. At decision step 670, the process ends if there is not an additional attribute and value pair to process. At step 680, the Router RD moves to the next attribute and value pair and proceeds to decision step 630.

In an embodiment, the AVAC message format comprises a Message Type attribute set to a value of AVAC, a Number of New Attribute-Value Pair attribute assigned to the number of attribute and value pairs contained within the message, and a number of De-advertised Attribute-Value Pair entries containing the attribute and value pairs being distributed within the AVAC message by the Router RD. The Number of De-advertised Attribute-Value Pairs field may indicate how many De-advertised attribute and value pairs are expected in the RDEA message. In an embodiment, if there is no aggregation in the AVAC message, then the number of de-advertised attribute and value pair is 1.

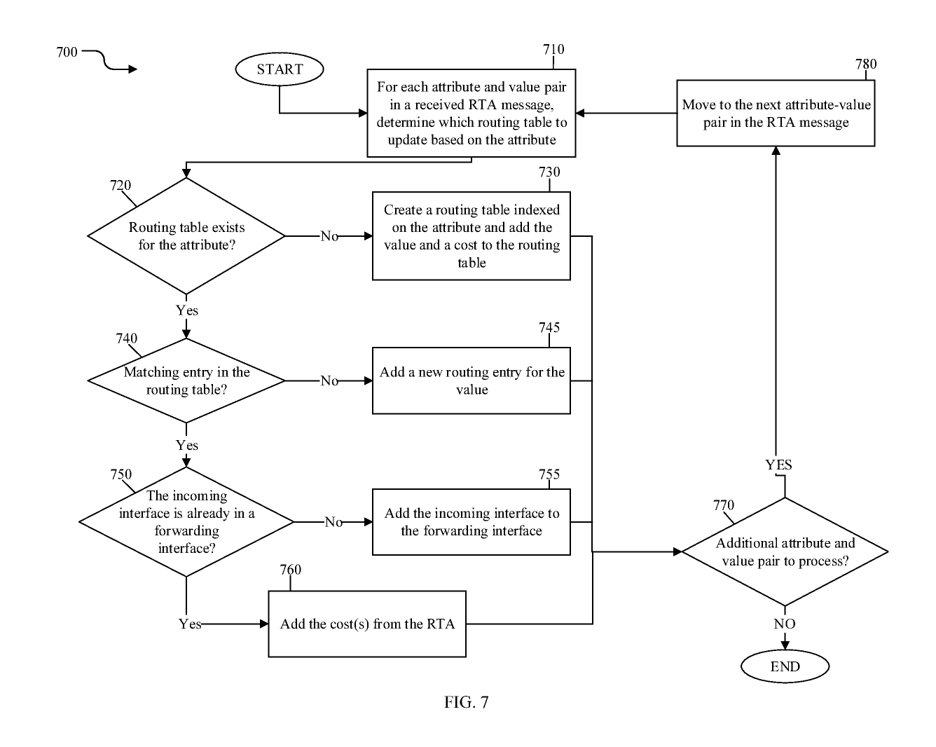

FIG. 7 is a flowchart of an embodiment of a method 700 employed by an NE, such as Router 220, NE 300, and/or Router RD 400, configured within an ICN, such as ICN 210, to process an RTA message. Method 700 may be implemented when the Router RD receives an RTA message. At step 710, the Router RD determines which routing table to update based on the attribute of a current attribute and value pair from a received RTA message. At decision step 720, the Router RD proceeds to step 730 if no routing table exists for the attribute. At decision step 720, the Router RD proceeds to decision step 740 if a routing table exists for the attribute. At step 730, the Router RD creates a routing table that is indexed on the attribute and adds the value (of the attribute and value pair) and a cost (or path metric) associated with the attribute and value pair to the routing table. In an embodiment, the Router RD calculates the cost by adding the cost of included in the RTA message and the cost from itself to the originator of the RTA message. For example, if the cost is the hop number, then the cost is increased by 1. The Router RD then proceeds to decision step 770. At decision step 740, the Router RD proceeds to step 745 if there is not a matching entry for the attribute and value pair in the routing table. At decision step 740, the Router RD proceeds to decision step 750 if there is a matching entry for the attribute and value pair in the routing table. At step 745, the Router RD adds a new routing entry for the value (of the attribute and value pair) and proceeds to decision step 770. At decision step 750, the Router RD proceeds to step 755 if an incoming interface of the received RTA message is not already a forwarding interface. At decision step 750, the Router RD proceeds to step 760 if an incoming interface of the received RTA message is already in a forwarding interface assigned to the attribute and value pair. At step 755, the Router RD adds the incoming interface to the forwarding interface and proceeds to decision step 770. At step 760, the Router RD adds the cost(s) from the RTA updates to the cost(s) in the matching entry based on the cost(s) included in the RTA message for that entry and indicates that there may be multiple IoT resources to be found via the same interface with different costs. At decision step 770, the Router RD proceeds to step 780 if there is an additional attribute and value pair to process. At decision step 770, the process ends if there is not an additional attribute and value pair to process. At step 780, the Router RD moves to the next attribute and value pair and proceeds to step 710.

In various embodiments, a Router RD, such as Router 220 and/or Router RD 400, distributes routing tables to neighbors within the ICN through an RTA message. In an embodiment, the Router RD distributes to neighbors that are directly attached to the Router RD. The Router RD may employ a modified distance-vector algorithm, which is iterative, asynchronous, and distributed. In an embodiment, algorithm is considered modified because the routing table maintains all the possible forwarding interfaces with associated cost in addition to the forwarding interface with the smallest cost. The modified distance-vector algorithm may not perform the comparison as to which forwarding interface has the lowest cost and may add the new forwarding interface and an associated cost to the routing table. In an embodiment, the routing table establishment is distributed through a mechanism where each Router RD receives routing tables from one or more neighboring Router RDs, performs a calculation, and then distributes the results of it calculation back to the neighbors. In an embodiment, the establishment of a routing table is iterative in that this process continues until no more new advertisement messages (including the messages introduced above, e.g., RDEA and AVAC). In an embodiment, the establishment of a routing table may be asynchronous in that it does not require all the Router RDs to operate at the same time with each other.

A Router RD may maintain multiple routing tables based on the attributes. In an embodiment, an RTA message format comprises a Message Type attribute set to a value of RTA, a sub-type attribute, and an Updated-Routing-Entries-During -the-Current-Period attribute, which is sent to all the interfaces of the Router RD when there are updates to the routing table during the current period.

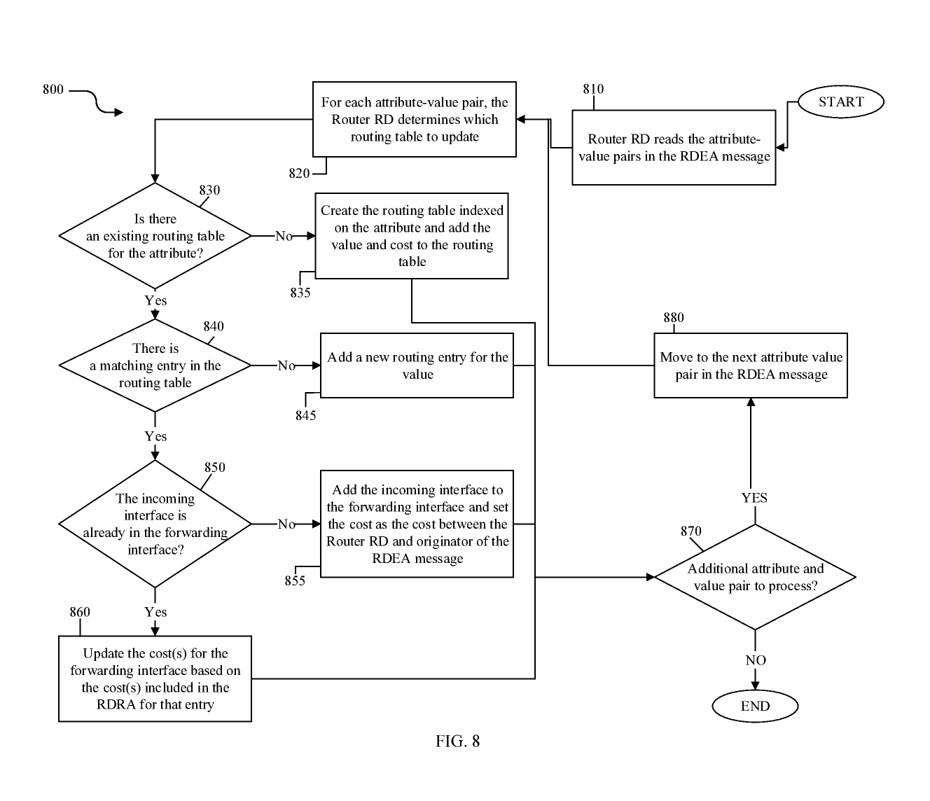

FIG. 8 is a flowchart of an embodiment of a method 800 employed by an NE, such as Router 220, NE 300, and/or Router RD 400, configured within an ICN, such as ICN 210, to process an RDEA message. Method 800 may be implemented when the Router RD receives an RDEA message. At step 810, the Router RD reads the attribute and value pairs in the RDEA message. At step 820, the Router RD, for each attribute and value pair, the Router RD determines which routing table to update. At decision step 830, the Router RD, proceeds to step 835 if there is not an existing routing table for the attribute. At decision step 830, the Router RD proceeds to decision step 840 if there is an existing routing table for the attribute. At step 835, the Router RD creates a routing table indexed on the attribute and adds the value and cost to the routing table. In an alternate embodiment, the Router RD may discard the attribute and value pair based on a popularity of the attribute and value pair. The Router RD then proceeds to decision step 870. At decision step 840, the Router RD proceeds to step 845 if there is no matching entry in the routing table for the attribute and value pair. At decision step 840, the Router RD proceeds to decision step 850 if there is a matching entry in the routing table for the attribute and value-pair. At step 845, the Router RD adds a new routing entry for the value in the routing table for the attribute and proceeds to decision step 870. At decision step 850, the Router RD proceeds to step 855 if the incoming interface is not already in the forwarding interface. At decision step 850, the Router RD proceeds to step 860 if the incoming interface is already in the forwarding interface. At step 855, the Router RD adds the incoming interface to the forwarding interface and sets the cost as the cost between the Router RD and originator of the RDEA message. The Router RD then proceeds to decision step 870. At step 860, the Router RD updates the cost(s) for the forwarding interface based on the cost(s) included in the RDRA for that entry. At decision step 870, the Router RD proceeds to step 880 if there is an additional attribute and value pair to process. At decision step 870, the process ends if there is no additional attribute and value pair to process. At step 880, the Router RD moves to the next attribute and value pair and proceeds to step 820.

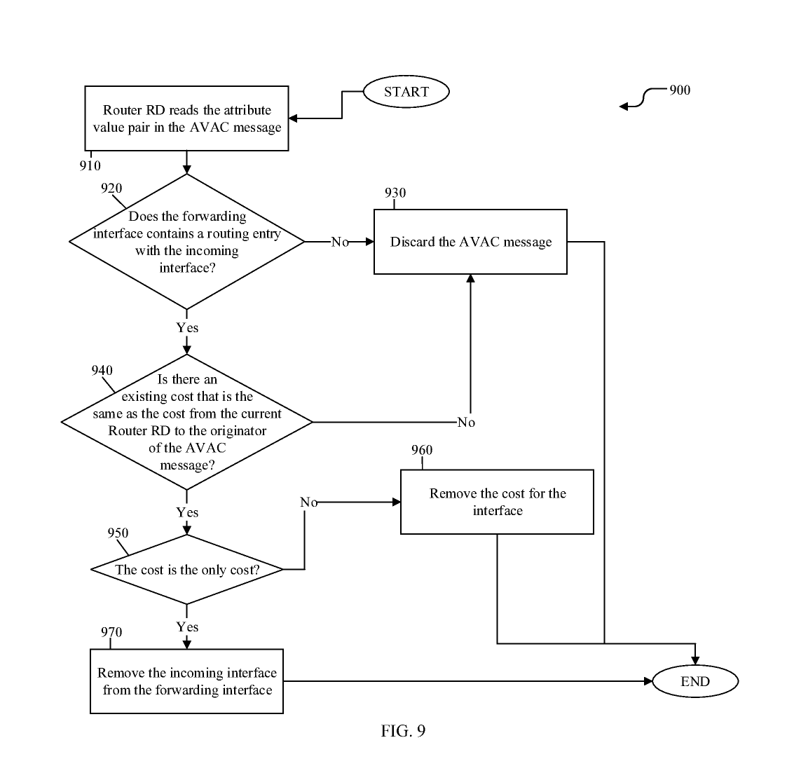

FIG. 9 is a flowchart of an embodiment of a method 900 employed by an NE, such as Router 220, NE 300, and/or Router RD 400, configured within an ICN, such as ICN 210, to process an AVAC message. Method 900 may be implemented when the Router RD receives an AVAC message. At step 910, Router RD reads the attribute and value pair in the AVAC message. At decision step 920, the Router RD proceeds to step 930 if the forwarding interface does not contain a routing entry with the incoming interface. At decision step 920, the Router RD proceeds to decision step 940 if the forwarding interface contains a routing entry with the incoming interface. At step 930, the Router RD discards the AVAC message and the process ends. At decision step 940, the Router RD proceeds to step 930 if an existing cost is not equal to the cost from the current Router RD to the originator of the AVAC message. At decision step 940, the Router RD proceeds to decision step 950 if an existing cost is equal to the cost from the current Router RD to the originator of the AVAC message. At decision step 950, the Router RD proceeds to step 960 if the cost between the Router RD and the originator of the AVAC message is not the only cost for the forwarding interface. At decision step 950, the Router RD proceeds to step 970 if the cost between the Router RD and the originator of the AVAC message is the only cost for the forwarding interface. At step 960, the Router RD removes the cost for the interface and the process ends. At step 970, the Router RD removes the incoming interface from the forwarding interface and the process ends.

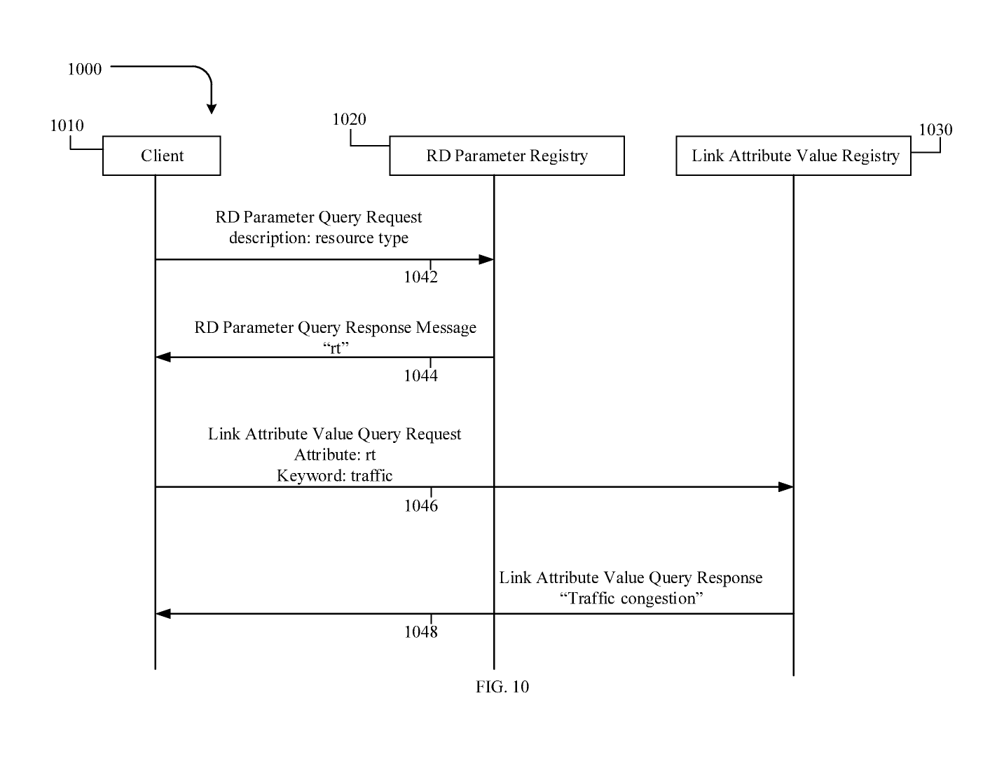

FIG. 10 is a protocol diagram describing communication 1000 between a client 1010, such as client 150 and/or clients 280 and 282, an NE, such as Router 220, NE 300, and/or Router RD 400, configured within an ICN, such as ICN 210, hosting an RD Parameter Registry 1020, and another NE, such as Router 220 and Router RD 400, configured within the ICN hosting a Link Attribute Value Registry 1030. The NE and the other NE may be the same physical device. In various embodiments, a client discovers IoT resources through the RD lookup interface. The client may or may not know RD parameters (attribute names) and link attribute values to request information regarding the IoT resources. In an embodiment, the lookup request message may employ the same RD parameters and link attribute values maintained in the routing tables distributed to the various devices throughout the CoRE.

In an embodiment, the client 1010 may send a query message to a device hosting the RD Parameter Registry 1020 to acquire attribute names to employ when requesting the attribute. Additionally, the client 1010 may send a query message to a device hosting the Link Attribute Value Registry 1030 to acquire the attribute values to use.

FIG. 10 shows an example where the client 1010 queries 1042 the RD Parameter Registry 1020 for a RD parameter name with a description of “Resource Type.” Client 1010 receives the RD parameter query response 1044 where the “rt” parameter corresponds to “Resource Type.” Client 1010 queries 1046 the Link Attribute Value Registry 1030 for the attribute value for the keyword of “Traffic”. The Link Attribute Value Registry 1030 returns 1048 the nearest match to the key word. In this example, the nearest matching link attribute value is “Traffic congestion.” Client 1010 formulates a lookup message for the IoT resource links with the Traffic congestion resource type. The lookup message comprises a string variable set to “GET /rd-lookup/res?rt=Traffic congestion.”

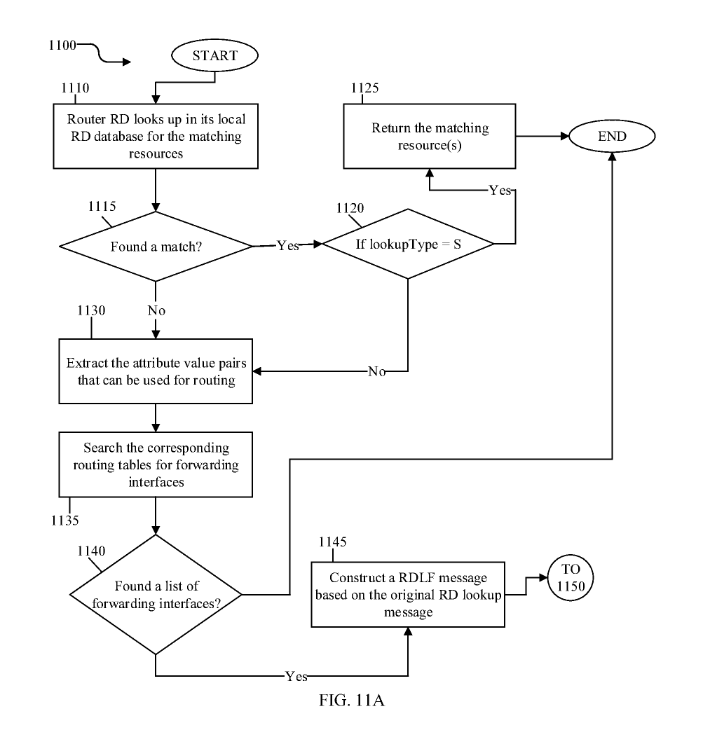

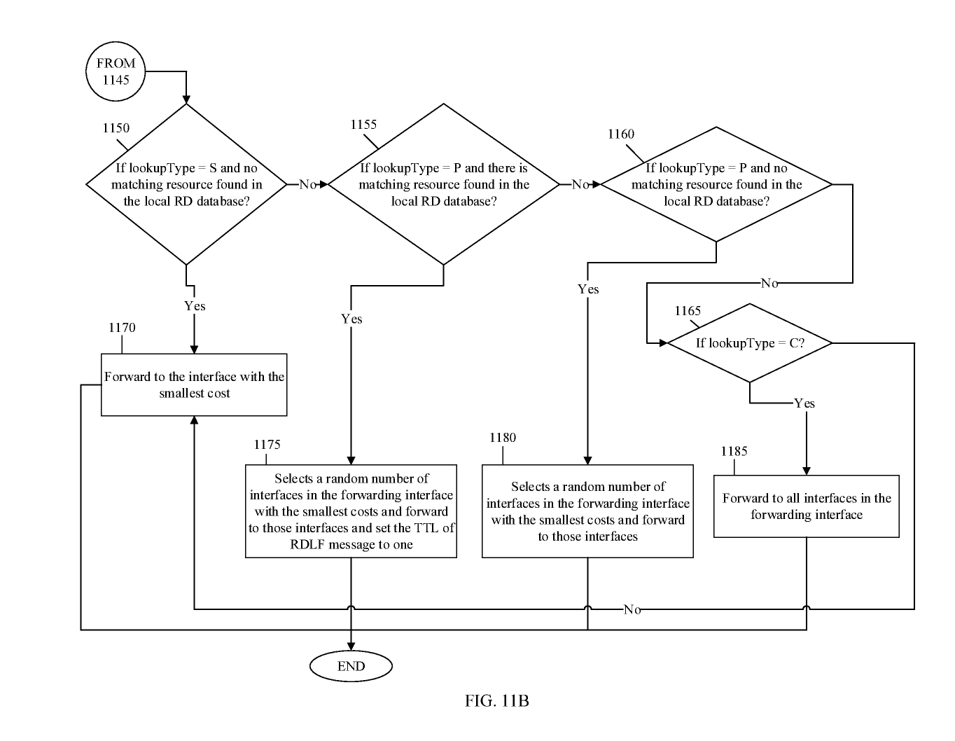

FIGS. 11A and 11B are a flowchart of an embodiment of a method 1100 employed by an NE, such as Router 220, NE 300, and/or Router RD 400, configured within an ICN, such as ICN 210, to process an RD lookup message. In an embodiment, a client may send an RD lookup message to an assigned host Router RD as the first hop. Method 1100 may be implemented when the Router RD is serving as a host Router RD for a client and receives an RD lookup message from the client. In various embodiments, because the Router RD maintains the interfaces discovered through the RDEA and RTA messages for each attribute and value pairs, the client may specify how the results should be returned. The client may specify several options. In one embodiment, the client requests a matching resource with a least cost or smallest path metric to retrieve it. In one embodiment, a variable/field named lookupType may be added to the RD lookup request message. The lookupType may specify how the lookup should be done throughout the network. This field may will also be used by the Partial and Complete options discussed below. When the lookupType is set to Single, the requests is for one resource. When the lookupType is set to Partial, the requests is for a sub-set of the total number of resources matching the request. When the lookupType is set to Complete, the requests is for the number of resources found that match the request. In one embodiment, the count attribute in the RD lookup interface may be left unspecified. In an embodiment, the count attribute in the RD lookup interface may be left unspecified. Below are examples of RD lookup messages that may be sent from a client: (1) look up for a temperature resource type resource with the smallest cost from the client GET /rd-lookup/res?rt=Traffic congestion & lookupType=S; (2) look up for some temperature resource type resources with small costs from the client GET /rd-lookup/res?rt=Traffic congestion & lookupType=P; (3) look up for all temperature resource type resources in the network GET /rd-lookup/res?rt=Traffic congestion & lookupType=C.

At step 1110, the Router RD looks up in a local RD database for resource(s) matching the resource(s) in the RD lookup message. At decision step 1115, the Router RD proceeds to decision step 1120 if there is a match. At decision step 1115, the Router RD proceeds to step 1130 if there is a match. At decision step 1120, the Router RD proceeds to step 1125 if the lookup type is set to Single. At decision step 1120, the Router RD proceeds to step 1130 if the lookup type is not set to Single. At step 1125, the Router RD returns the matching resource(s) and the process ends. At step 1130, the Router RD extracts the attribute and value pairs that can be used for routing from the RD lookup message. At step 1135, the Router RD searches corresponding routing tables for forwarding interfaces for the attribute and value pairs. At decision step 1140, the Router RD proceeds to step 1145 if a list of forwarding interfaces is found. At decision step 1140, the process ends if no forwarding interfaces are found. At step 1145, the Router RD constructs an RD Lookup Forward (RDLF) message based on the original RD lookup message. In an embodiment, an RDLF message format comprises a Message Type attribute set to a value of RDLF, a lookupType attribute, a Time-To-Live (TTL) field used to specify how far the RDLF will be forwarded, and a list of attribute value pairs for routing. In various embodiments, the constructed RDLF message comprises a lookupType field set to the same value as the lookupType variable in the original RD lookup message and the attribute and value pairs are copied in the RDLF message for routing. In an embodiment, the TTL field of RDLF is set to the largest number of hops that can be traversed in the network as a default value.

At decision step 1150, the Router RD proceeds to step 1170 if the lookupType is set to Single and no matching resource is found in the local RD database. At step 1170, the Router RD forwards to the interface with the smallest cost (e.g., number of hops) and the process ends. At decision step 1150, the Router RD proceeds to decision step 1155 if the lookupType is not set to Single or a matching resource is found in the local RD database. At decision step 1155, the Router RD proceeds to step 1175 if the lookupType is set to Partial and there is a matching resource found in the local RD database. At step 1175, the Router RD selects a random number of interfaces in the forwarding interface with the smallest costs (e.g., smallest number of hops) and forwards the RDLF message to those interfaces, sets the TTL of RDLF message as one, and the process ends. At decision step 1155, the Router RD proceeds to decision step 1160 if the lookupType is not set to Partial or there is not a matching resource found in the local RD database. At decision step 1160, the Router RD proceeds to step 1180 if the lookupType is set to Partial and no matching resource found in the local RD database. At step 1180, the Router RD selects a random number of interfaces in the forwarding interface with the smallest costs (e.g., smallest number of hops) and forwards the RDLF message to those interfaces, and the process ends. At decision step 1160, the Router RD proceeds to decision step 1180 if the lookupType is not set to Partial or if a matching resource is found in the local RD database. At decision step 1165, the Router RD proceeds to step 1185 if the lookupType is set to Complete. At step 1185, the Router RD forwards the RDLF message to all interfaces in the forwarding interface and the process ends. At decision step 1165, the Router RD proceeds to step 1170 if the lookupType is not set to Complete.

In various embodiments, when a Router RD, such as Router 220 or Router RD 400, receives an RDLF message, the processing of the RDLF message is substantially similar to the processing of a RD lookup message as described above with notable differences of 1) the Router RD does not construct an RDLF message but instead updates the TTL value within the received RDLF message if it exists and 2) the Router RD may discard the RDLF message if the TTL reaches 0 after the the Router RD decrements by one.

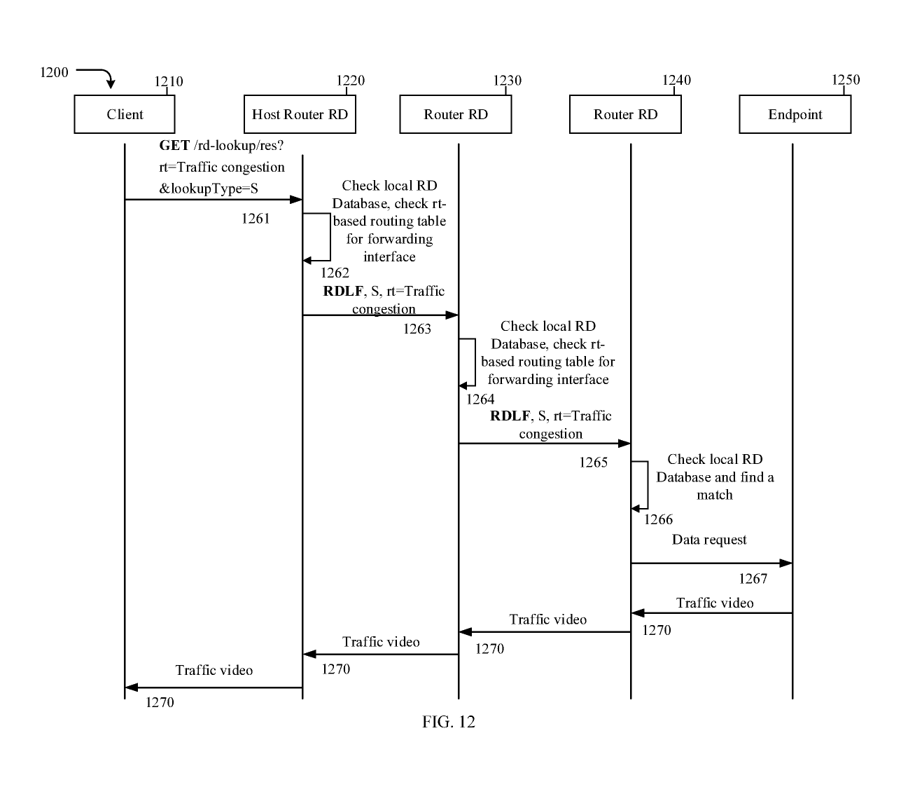

FIG. 12 is a protocol diagram describing an embodiment of a message flow 1200 of resource lookup request from a client 1210 through an ICN, such as ICN 210. In the disclosed embodiment, the ICN comprises three Router RDs, Host Router RD 1220, Router RD 1230, and Router RD 1240, along a path from the client 1210 to the Endpoint 1250. Host Router RD 1220, Router RD 1230, and Router RD 1240 are substantially similar to Router 220 and/or Router RD 400. In the disclosed embodiment, the client 1210 first sends an RD lookup request to the assigned Host Router RD 1220 by employing the standard RD lookup interface 1261. The Host Router RD 1220 then queries a local RD Database for a matching resource(s) 1262. In this example, without finding a match, the Host Router RD 1220 then queries an rt-based routing table for the forwarding interface 1261. The Host Router RD 1220 then generates a new RDLF message and sends the message to the forwarding interface 1263. Router RD 1230 receives the RDLF message and follows the same procedure as the Router RD except for creating the new RDLF message 1264. Router RD 1230 then forwards the RDLF message to the forwarding interface 1265. Router RD 1240 then receives the RDLF message. Router RD 1240 queries a local RD Database and finds a match 1266. The matching RD entry contains information regarding the requested resource(s). Router RD 1230 may return the RD entry as the lookup response to the client 1270. In an alternate example, Router RD 1230 may retrieve the resource(s) from the endpoint on behalf of the client 1267 and send back the requested resource to the client 1270.

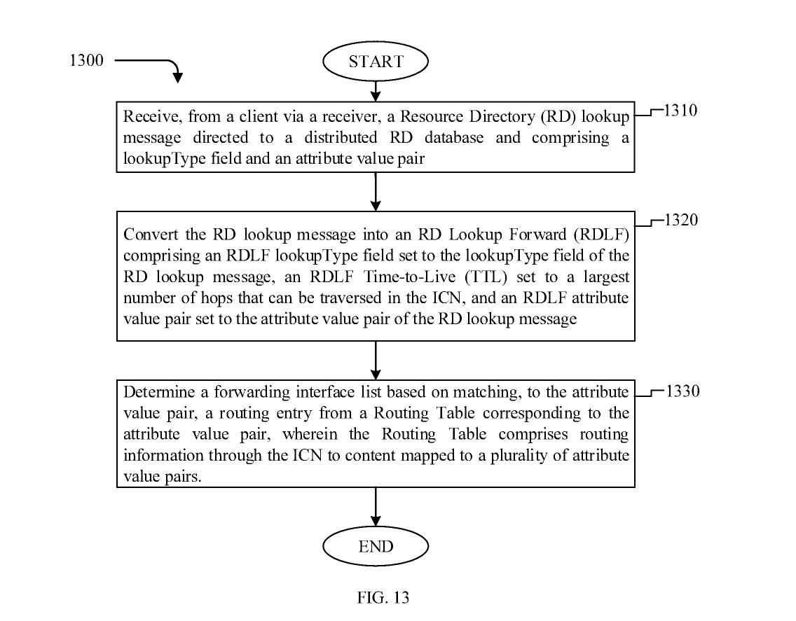

FIG. 13 is a flowchart of an exemplary embodiment employed by an NE, such as such as Router 220, NE 300, and/or Router RD 400, in an ICN, such as ICN 210, to receive and process an RD lookup message comprising an attribute value pair received from a client when an IoT resource corresponding to the attribute value pair is not stored on the NE in a local portion of a distributed RD database or an endpoint serviced directly by the NE. At step 1310, the NE receives, from a client via a receiver, a RD lookup message directed to a distributed RD database and comprising a lookupType field and an attribute value pair. At step 1320, the NE converts the RD lookup message into an RDLF comprising an RDLF lookupType field set to the lookupType field of the RD lookup message, an RDLF TTL set to a largest number of hops that can be traversed in the ICN, and an RDLF attribute value pair set to the attribute value pair of the RD lookup message. At step 1330, the NE determines a forwarding interface list based on matching, to the attribute value pair, a routing entry from a Routing Table corresponding to the attribute value pair, wherein the Routing Table comprises routing information through the ICN to content mapped to a plurality of attribute value pairs.

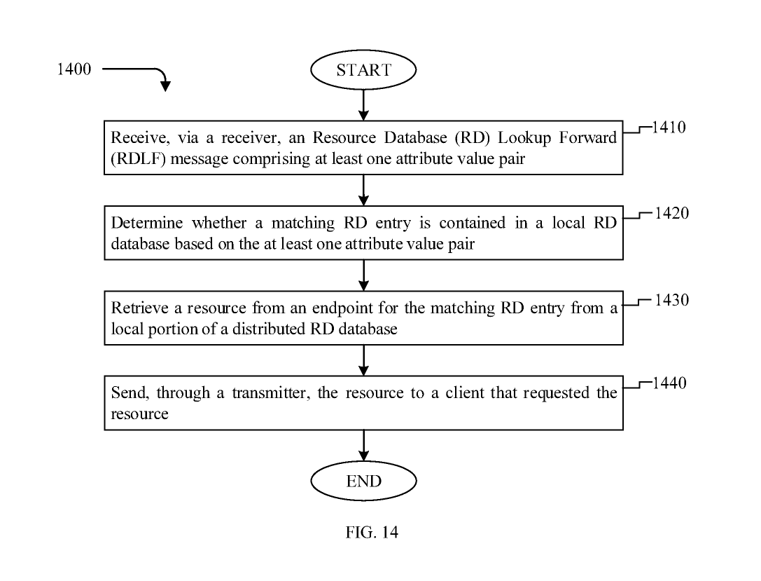

FIG. 14 is a flowchart of an exemplary embodiment employed by an NE, such as such as Router 220, NE 300, and/or Router RD 400, in an ICN, such as ICN 210, to receive and process an RD lookup message comprising an attribute value pair received from a client when an IoT resource corresponding to the attribute value pair is not stored on the NE in a local portion of a distributed RD database or an endpoint serviced directly by the NE. At step 1410, the NE receives, via a receiver, an RDLF message comprising at least one attribute value pair. At step 1420, the NE determines whether a matching RD entry is contained in a local RD database based on the at least one attribute value pair. At step 1430, the NE retrieves a resource from an endpoint for the matching RD entry from a local portion of a distributed RD database. At step 1440, sends, through a transmitter, the resource to a client that requested the resource.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A network element (NE) configured to operate in an information centric network (ICN), the NE comprising:
a receiver configured to receive, from an endpoint, an Internet of Things (IoT) resource registration comprising a Resource Directory (RD) entry comprising an attribute value pair;
a memory comprising a local portion of a distributed RD database and a candidate-to-be-published list;
a processor coupled to the receiver and the memory, wherein the processor is configured to:
insert the attribute and value pair in the candidate-to-be-published list; and
store the RD entry in the local portion of the distributed RD database; and
a transmitter coupled to the processor and configured to transmit an RD Entry Advertisement (RDEA) message comprising attribute value pairs copied from the candidate-to-be-published list to a plurality of neighboring NEs within the ICN for storage in a remote portion of the distributed RD database when a number of the attribute value pairs in the candidate-to-be-published list reaches a threshold.

2. The NE of claim 1, wherein stored RD entry comprises a time-to-live (TTL) attribute.

3. The NE of claim 1, wherein the transmitter is further configured to send an Attribute-Value Advertisement Cancellation (AVAC) message comprising the attribute value pair to the neighboring NEs within the ICN to remove the RD entry from the remote portion of the distributed RD database when the RD entry has expired based on the TTL attribute.

4. The NE of claim 1, wherein the receiver is further configured to receive, from the endpoint, a deletion request comprising a second RD entry comprising a second attribute value pair, wherein the processor is further configured to remove the second RD entry from the local portion of the distributed RD database, and wherein the transmitter is further configured to send an Attribute-Value Advertisement Cancellation (AVAC) message to the neighboring NEs within the ICN comprising the second attribute value pair to remove the second RD entry from the remote portion of the distributed RD database.

5. The NE of claim 1, wherein the receiver is further configured to receive, on an incoming interface, a message comprising a routing entry, and wherein the processor is further configured to:
calculate a metric based on a network path from the NE to an originator of the message;
update a Routing Table with the routing entry and the metric; and
assign the incoming interface as a forwarding interface for the routing entry in the Routing Table.

6. The NE of claim 1, wherein the receiver is further configured to receive, on an incoming interface, a message comprising a second attribute value pair, and wherein the processor is further configured to:
calculate a path metric based on a network path from the NE to an originator of the RDEA message;
update a Routing Table with the second attribute value pair and the metric; and
assign the incoming interface as a forwarding interface for the second attribute value pair in the Routing Table.

7. The NE of claim 1, wherein the receiver is further configured to receive, on an incoming interface, a message comprising a second attribute value pair and a path metric, and wherein the processor is further configured to remove the path metric from a forwarding interface list associated with the second attribute value pair when other path metrics are included in the forwarding interface list.

8. The NE of claim 1, wherein the NE is configured as a host RD for the endpoint.

9. The NE of claim 1, wherein the NE is configured as a repository for links to resources hosted by a plurality of endpoints including the endpoint from which the IoT resource registration is received.

10. A method implemented in a network element (NE) configured to operate in an information centric network (ICN), the method comprising:
receiving, from a client via a receiver, a Resource Directory (RD) lookup message directed to a distributed RD database and comprising a lookupType field and an attribute value pair;
converting the RD lookup message into an RD Lookup Forward (RDLF) comprising an RDLF lookupType field set to the lookupType field of the RD lookup message, an RDLF Time-To-Live (TTL) set to a largest number of hops that can be traversed in the ICN, and an RDLF attribute value pair set to the attribute value pair of the RD lookup message; and
determining a forwarding interface list based on matching, to the attribute value pair, a routing entry from a Routing Table corresponding to the attribute value pair, wherein the Routing Table comprises routing information through the ICN to content mapped to a plurality of attribute value pairs.

11. The method of claim 10 further comprising:
receiving, from the client via the receiver, a second Resource Directory (RD) lookup message comprising a second lookupType field and a second attribute value pair;
determining whether a matching RD entry is contained in a local portion of the distributed RD database stored in a memory based on the second attribute value pair; and
returning, through a transmitter, the matching RD entry to the client when the matching RD entry is contained in the local portion of the distributed RD database.

12. The method of claim 10 further comprising:
selecting, from the forwarding interface list, a forwarding interface for forwarding the RDLF message by determining the forwarding interface that most closely satisfies a pathing metric; and
forwarding the RDLF message through the forwarding interface.

13. The method of claim 10 further comprising:
setting the RDLF TTL field to one;
determining a number of forwarding interfaces from the forwarding interface list, wherein the number of forwarding interfaces is based on a random number; and
forwarding the RDLF message through the forwarding interfaces.

14. The method of claim 10 further comprising:
determining a plurality of forwarding interfaces from the forwarding interface list based on the plurality of forwarding interfaces most closely matching a pathing metric; and
forwarding the RDLF message through the forwarding interfaces.

15. The method of claim 10 further comprising forwarding the RDLF message through all of the forwarding interfaces contained in the forwarding interface list.

16. The method of claim 10, wherein the NE is configured as a host RD for the client.

17. A method implemented in a network element (NE) configured to operate in an information centric network (ICN), the method comprising:
receiving, via a receiver, an Resource Database (RD) Lookup Forward (RDLF) message comprising at least one attribute value pair;
determining whether a matching RD entry is contained in a local RD database based on the at least one attribute value pair;
retrieving a resource from an endpoint for the matching RD entry from a local portion of a distributed RD database; and
sending, through a transmitter, the resource to a client that requested the resource.

18. The method of claim 17 further comprising caching the resource in a memory.

19. The method of claim 17 further comprising sending the RD entry to the client through the transmitter.

20. The method of claim 17, wherein the NE is configured as a host RD for the client.
